(19) United States
(12) Patent Application Publication
(10) Pub. No.: US 2015/0032630 A1
(43) Pub. Date: Jan. 29, 2015

(54) SYSTEMS AND METHODS FOR POSTPONING CHECK SETTLEMENT

(71) Applicant: First Data Corporation, Greenwood Village, CO (US)

(72) Inventor: Reginald Todd Mitchell, Pearland, TX (US)

(21) Appl. No.: 14/339,085

(22) Filed: Jul. 23, 2014

Related U.S. Application Data
(60) Provisional application No. 61/857,992, filed on Jul. 24, 2013.

(51) Int. Cl. G06Q 20/04

(52) U.S. Cl. CPC G06Q 20/042
USPC 705/45

(57) ABSTRACT

Systems and methods are provided for postponing check settlement. According to one or more embodiments, a method is provided. The method may include receiving, by a computer including one or more processors, check information associated with a check on a current date. The method may also include determining, by the computer, a destination account identifier for the check and determining whether to postpone settlement of the check until after the current date. Furthermore, the method may include identifying, by the computer upon a positive determination to postpone settlement of the check, a delayed settlement date associated with the check. Additionally, the method may include storing an association between the check information, the delayed settlement date, and the destination account identifier in a database in communication with the computer

### CROSS-REFERENCE TO RELATED APPLICATION

This application claims the benefit of U.S. Provisional Application No. 61/857,992, filed Jul. 24, 2013, entitled “Systems and Methods for Postponing Check Settlement,” which is incorporated herein by reference.

### FIELD OF THE DISCLOSURE

The disclosure generally relates to processing checks, and more particularly relates to systems and methods for postponing check settlement.

### BACKGROUND

Certain systems in communication with point of sale devices may be able to convert physical checks into electronic form. Once a check has been converted to electronic form, there may be waiting before the check is settled. In some cases, a consumer who issued a physical check may wish to delay and/or postpone settlement of the check for even longer periods of time.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example system for postponing check settlement in accordance with one or more example embodiments.

FIG. 2 illustrates a block diagram of check information in accordance with one or more example embodiments.

FIG. 3 illustrates a block diagram of an example data flow for postponing check settlement in accordance with one or more example embodiments.

FIG. 4 illustrates a flow diagram of an example method for postponing check settlement in accordance with one or more example embodiments.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like, but not necessarily the same or identical, elements throughout. Hence, if a feature is used across several drawings, the number used to identify the feature in the drawing where the feature first appeared will be used in later drawings.

### DETAILED DESCRIPTION

### Overview

Described herein are systems and methods for postponement of check settlement. Broadly, the systems and methods described herein may facilitate the delay and/or postponement of settling checks issued by a consumer to a merchant of merchant device

Thus, according to one or more embodiments of the disclosure, a method is provided for postponing check settlement. The method may include receiving, by a computer including one or more processors, check information associated with a check on a current date. The method may also include determining, by the computer, a destination account identifier for the check and determining whether to postpone settlement of the check until after the current date. Furthermore, the method may include identifying, by the computer upon a positive determination to postpone settlement of the check, a delayed settlement date associated with the check. Additionally, the method may include storing an association between the check information, the delayed settlement date, and the destination account identifier in a database in communication with the computer.

According to one or more other embodiments of the disclosure, a device is provided. The device may include at least one memory for storing data and computer-executable instructions. The device may also include at least one processor to access the at least one memory and to execute the computer-executable instructions. The at least one processor may be configured to execute the instructions to receive check information associated with a check on a current date. The at least one processor may also be configured to execute the instructions to determine a destination account identifier for the check and determine whether to postpone settlement of the check until after the current date. The at least one processor may further be configured to execute the instructions to identify, upon a positive determination to postpone settlement of the check, a delayed settlement date associated with the check. Additionally, the at least one processor may further be configured to execute the instructions to store an association between the check information, the delayed settlement date, and the destination account identifier in a database in communication with the device.

According to one or more other embodiments of the disclosure, a non-transitory computer-readable medium is provided. The computer-readable may store computer-executable instructions, that when executed by at least one processor, causes the at least one processor to receive check information associated with a check on a current date. The computer-readable may store further instructions that cause the at least one processor to determine a destination account identifier for the check and determine whether to postpone settlement of the check until after the current date. Furthermore, the computer-readable may store instructions that cause the at least one processor to identify, upon a positive determination to postpone settlement of the check, a delayed settlement date associated with the check. The computer-readable may also store instructions that cause the at least one processor to store an association between the check information, the delayed settlement date, and the destination account identifier in a database in communication with the device.

These and other embodiments of the disclosure will be described in more detail through reference to the accompanying drawings in the detailed description of the disclosure that follows. This brief introduction, including section titles and corresponding summaries, is provided for the reader's convenience and is not intended to limit the scope of the claims or the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Embodiments

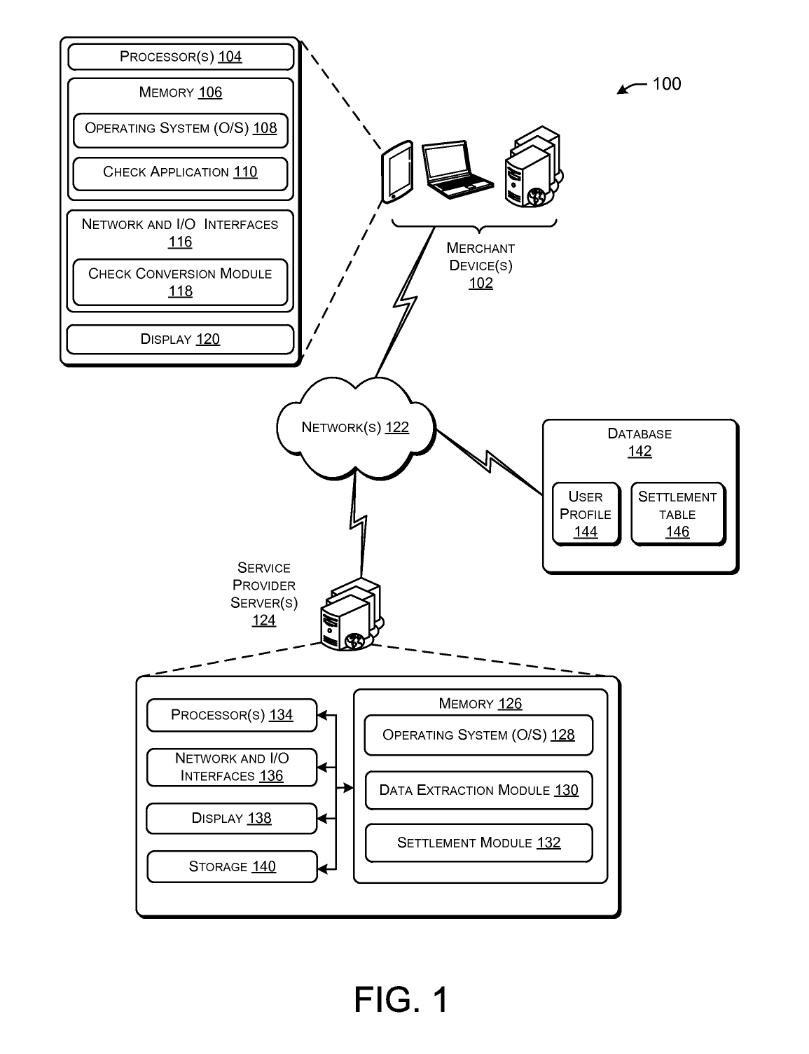

With reference now to FIG. 1, a system 100 for postponing check settlement is shown according to one or more embodiments of the disclosure. The system 100 may include one or more merchant device(s) 102. In general, the merchant device 102 may refer to any type of electronic device, and, more particularly, may refer to one or more of the following: a wireless communication device, a portable electronic device, a telephone (e.g., cellular phone, smart phone), a computer (e.g., laptop computer, tablet computer), a wearable computer device, a portable media player, a personal digital assistant (PDA), or any other electronic device having a networked capability. The merchant device(s) 102 may include one or more computer processors 104, and a memory 106 storing an operating system 108 and a check application 110. In addition, the merchant device(s) 102 may include a, network and I/O interfaces 116, and a display 120. In certain embodiments, the merchant device(s) 102 may include one or more sensors capable of gathering information associated with a present environment of the merchant device(s) 102, or similar hardware devices, such as a camera, microphone, antenna, a gesture capture or detection device, or Global Positioning Satellite (GPS) device.

The computer processors 104 may comprise one or more cores and may be configured to access and execute (at least in part) computer-readable instructions stored in the memory 106. The one or more computer processors 104 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The merchant device 102 may also include a chipset (not shown) for controlling communications between the one or more processors 104 and one or more of the other components of the merchant device 102. In certain embodiments, the merchant device 102 may be based on an Intel® architecture or an ARM® architecture, and the processor(s) and chipset may be from a family of Intel® processors and chipsets. The one or more processors 104 may also include one or more application-specific integrated circuits (ASICs) or application-specific standard products (ASSPs) for handling specific data processing functions or tasks.

The memory 106 may include one or more computer-readable storage media (CRSM). In some embodiments, the memory 106 may include non-transitory media such as random access memory (RAM), flash RAM, magnetic media, optical media, solid state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106 may store an operating system 108 that includes a plurality of computer-executable instructions that may be implemented by the computer processor to perform a variety of tasks to operate the interface(s) and any other hardware installed on the merchant device 102. The memory 106 may also store content that may be displayed by the merchant device 102 or transferred to other devices (e.g., headphones) to be displayed or played by the other devices. The memory 106 may also store content received from the other devices. The content from the other devices may be displayed, played, or used by the merchant device 102 to perform any necessary tasks or operations that may be implemented by the computer processor or other components in the merchant device 102.

The network and I/O interfaces 112 may also include one or more communication interfaces or network interface devices to provide for the transfer of data between the merchant device 102 and another device (e.g., network server) via a network (not shown). The communication interfaces may include, but are not limited to: personal area networks (PANs), wired local area networks (LANs), wireless local area networks (WLANs), wireless wide area networks (WWANs), and so forth. The merchant device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the merchant device 102 and another device, such as an access point, a host computer, a server, a router, a reader device, and the like. The network may include, but is not limited to, the Internet, a private network, a virtual private network, a wireless wide area network, a local area network, a metropolitan area network, a telephone network, and so forth.

The display 120 may include, but is not limited to, a liquid crystal display, a light-emitted diode display, or an E-Ink™ display as made by E Ink Corp. of Cambridge, Mass. The display 120 may be used to show content to a user in the form of text, images, or video. In certain instances, the display 120 may also operate as a touch screen display that may enable the user to initiate commands or operations by touching the screen using certain finger or hand gestures.

The merchant device(s) 102 may also be in communication with one or more service provider server(s) 124, such as via a network 122. The service provider server(s) 124 may include one or more processor(s) 134 and at least one memory 126, which may store an operating system 128, a data extraction module 130, and a settlement module 132. Furthermore, the service provider server(s) 124 may include network and I/O interfaces 136, a display 138, and storage 140. In some implementations, the service provider server(s) 124 may be associated with one or more financial institutions and/or financial systems.

Furthermore, as shown in the embodiment of FIG. 1, a database 142 can be accessible by the user devices 102 and/or service provider computers 118 via the network(s) 116. The database 142 can include any type of data storage device and/or any number of data storage devices.

According to one or more embodiments, the merchant device(s) 102 may include point of sale devices and/or other types of devices associated with the merchant at various locations. To this end, in some implementations, the network and I/O interfaces 116 include a check conversion module 118 for generating electronic check information from a physical check. For example, a consumer may provide a physical check to a user of the merchant device(s) 102, such as a cashier, and/or any other employee of a merchant of the merchant device 102. The user may provide the physical check to the check conversion module 118. As such, the check conversion module 118 may be configured to perform optical character recognition (OCR) on the physical check. To this end, the check conversion module 118 may include a sensor, such as a camera, scanner, and/or any other type of image capturing to device to capture an image of the physical check and generate OCR data from image. Check information may then be determined based at least in part on the OCR data, such as via a check application 110.

Additionally, various other methods for receiving, retrieving, generating, and/or otherwise accessing the check information are also contemplated. For example, in some embodiments, the user of the merchant device(s) 102 may manually input check information associated with the physical check (e.g., via an interface provided by the check application 110), instead of providing the physical check to the check conversion module 118. Alternatively, the merchant device(s) 102 may include a microphone to receive check information from voice commands issued by the user of the merchant device 102.

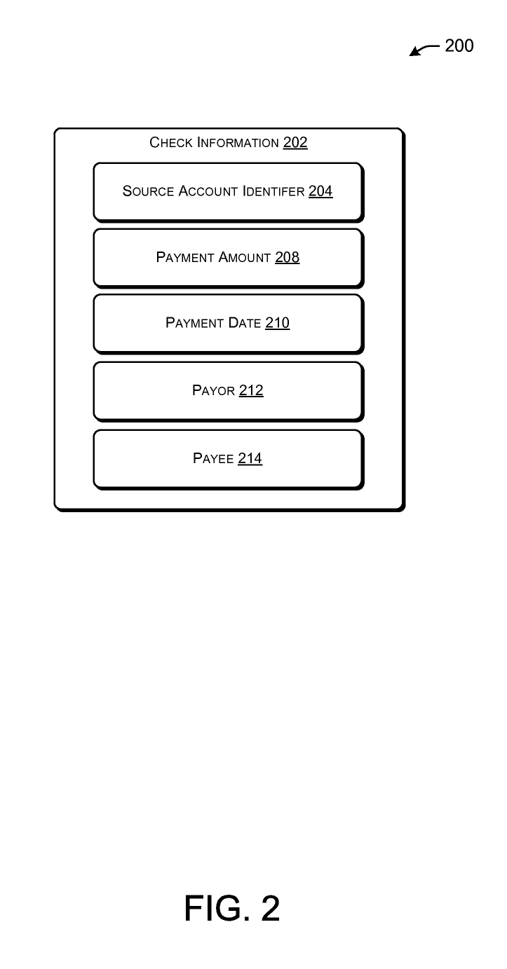

With respect to the check information, FIG. 2 illustrates a block diagram 200 illustrating one or more components that may be included in the check information 202, according to one or more example embodiments. The check information 202 may include various data associated with a physical check. For example, such data may include data associated with a source account identifier 204 corresponding to a source account from which the physical check is to withdraw funds, a payment amount 208, a payment date 210, a payor 212, a payee 214, and/or the like. It should be appreciated that the components of the check information 202 illustrated in FIG. 2 are not limiting or exhaustive, and that that the check information 202 may include other data as well.

According to one or more embodiments, the service provider server(s) 124 may be operated by, owned by, and/or otherwise associated with a service provider. The service provider may provide an electronic check service that facilitates conversion of physical checks into electronic form (e.g., generating check information 202 associated with physical checks). To this end, merchants may enroll in the electronic check service in order to generate (electronic) check information 202 from physical checks received at a point of sale. Furthermore, the electronic check service may also facilitate settlement of the checks based on the check information 202. In addition to merchants, consumers and/or any other types of potential users may also be able to enroll in the electronic check service. Enrollment may enable consumers to manage certain features with respect how their checks may be processed by the electronic check service.

In certain embodiments, the electronic check service may enable the consumer to postpone settlement of a check for a predetermined amount of time (e.g., for a number of days after receipt, until a particular date, and/or the like) according to various criteria. For example, to enroll in the electronic service, a user may provide information associated with one or more bank accounts from which his/her physical checks may withdraw funds. The electronic check service may provide unique account identifiers for each account. Furthermore, the electronic check service may generate a user profile 144 for the enrolled consumer, which may be configured to store various preferences associated with the user and/or with the account identifiers. Such preferences may be configurable by the consumer and/or any other authorized user. The user profile 144 may be stored in any storage location, such as in the database 142. In certain cases, the consumer may configure preferences with respect to delaying settlement of checks. Such preferences may be applied to check and/or accounts as a whole or on an individual basis. For example, for a certain account, the enrolled consumer may wish to delay/postpone settlement of all checks for that account until five days after receipt, by the service provider server(s) 124, of the respective check information 202 for those checks. As another example, for checks received after a first date, a consumer may wish delay/postpone settlement of those checks until after a second date. It will be appreciated that the described preferences are merely exemplary, and that numerous other types of preferences with respect to delaying/postponing check settlements are also contemplated. Alternatively, in other embodiments, instead of relying on stored preferences associated with consumer enrollment in the electronic check service, the check application 110 at the merchant device(s) 102 may be configured to receive, in real-time or near real-time, direct requests from the consumer to delay/postpone checks for a predetermined period of time and/or until a certain date.

Referring back to the check application 110, the check application 110 may be configured to receive, retrieve, and/or otherwise access the check information 202 (e.g., via the check conversion module 118 and/or directly from a consumer of the merchant device(s) 102). The check application 110 may further be configured to transmit the check information 202, as well as an identifier for a destination account (e.g., bank account information associated with a merchant of the merchant device(s) 102) in which funds from the check are to be deposited, to the service provider server(s) 124. In certain embodiments, the check application 110 may also receive one or more requests from the consumer to delay/postpone settlement of the physical check associated with the check information 202. Such requests may also be transmitted to the service provider server(s) 124.

Upon receipt of the check information 202, the service provider server(s) 124 may determine, such as via the data extraction module 130, a source account identifier 204 from the check information 202. The service provider server(s) may also receive, from the merchant device(s) 102, the destination account identifier associated with the merchant and/or a financial institution associated with the merchant. In other implementations, the service provider server(s) 124 may instead be configured to determine the destination account identifier associated with the merchant based on the received check information 202. For example, the service provider server(s) 124 may store associations between merchants and respective account identifiers associated with the merchants. As such, upon receipt of the check information 202, the service provider server(s) 124 may identify the payee 214 as the merchant and determine the destination account identifier associated with the merchant.

As previously discussed, the service provider server(s) 124 may also be configured to receive a request, from the consumer (via the merchant device(s) 102), to delay settlement of the check associated with check information 202. However, in other implementations, the data extraction module 130 may be configured to access the database 142 to search for a user profile, such as user profile 144, which may be associated with the source account identifier 204 of the check. For example, the database 142 may store associations between one or more user profiles and one or more source account identifiers, such that using a particular source account identifier, the data extraction module 130 may be configured to determine a corresponding user profile. which can include a user account identifier corresponding to the source account identifier 204. To this end, a user profile 144 may be configured to store one or more preferences, instructions, rules, and/or the like that may indicate a desire to delay settlement of checks. Thus, if the data extraction module 130 identifies a user profile 144 associated with the source account identifier 204, the data extraction module 130 may determine whether there are any preferences, instructions, rules, and/or any other stored indications to delay and/or postpone settlement of checks that are to withdrawal from funds from the account associated with the source account identifier 204. Upon a positive determination to delay and/or postpone the settlement of the check, the data extraction module 130 may identify a delayed settlement date until which to postpone settlement of the check. The delayed settlement date may be determined according to preferences stored in the user profile 144. For example, the user profile 144 may indicate preferences to delay settlement of checks by a certain number of days, to delay settlement until a particular date or dates, and/or any other types of rules or preferences. In other implementations, the delayed settlement date may be identified based on a direct request from a consumer.

In addition, the data extraction module 130 may be configured to store an association between the delayed settlement date and check settlement information associated with the check in the database 142. The check settlement information may include the check information 202 and the destination account identifier associated with the check. In some implementations, such an association may be stored in a settlement table 146 in the database 142. As such, the settlement table 146 may be indexed by settlement dates, and the service provider server(s) 124 may be configured to periodically access the settlement table 146 to settle one or more checks on certain settlement dates. On the other hand, if there is no indication to delay/postpone settlement of the check, or if no match between the source account identifier 204 and any account identifier stored in the database 142 exists, the data extraction module 130 may transmit the check information 202 and the destination account identifier to the settlement module 132 to immediately begin settlement of the check.

In other embodiments, where the check application 110 directly receives a request to delay/postpone settlement of the check from a consumer, such a request may be transmitted to the data extraction module 130 along with the check information 202. Furthermore, the request may specify the delayed settlement date until which to postpone settlement of the check. Again, the data extraction module 130 may be able to determine, from the check information 202, the source account identifier 204. To this end, the data extraction module 130 may be configured to store an association between the delayed settlement date and check settlement information associated with the check (e.g., which may include the check information 202 and the destination account identifier) into database 142, such as in the settlement table 146. It will be appreciated that the settlement table 146 is merely an example structure in which such associations may be stored and that any other data structures may also be used to store such associations.

According to certain embodiments, the settlement module 132 may be configured to periodically access the settlement table 146 in the database 142 to determine whether any checks are to be settled (e.g., according to their respective check information 202 and destination account identifiers). In certain implementations, the settlement module 132 may access the settlement table 146 on a daily basis, although other time intervals are also contemplated in other embodiments. For instance, the settlement module 132 may be configured to determine a current date. Moreover, the settlement module 132 may access the settlement table 146 to identify check settlement information associated with any checks (e.g., entries in the settlement table 146) that having settlement dates matching the current date. Upon any checks having settlement dates matching the current date, the settlement module 132 may settle the checks according to their respective check settlement information.

While FIG. 1 illustrates the check application 110 as stored in the merchant device(s) 102, it should be appreciated that the functionality provided by the check application 110 and/or any of its components may be distributed among any combination of devices/components included in the system 100. For example, in some implementations, the functionality provided by the data extraction module 130 and/or the settlement module 132. Furthermore, in some embodiments, the check conversion module 118 may be a separate, peripheral device in communication with the merchant device(s) 102.

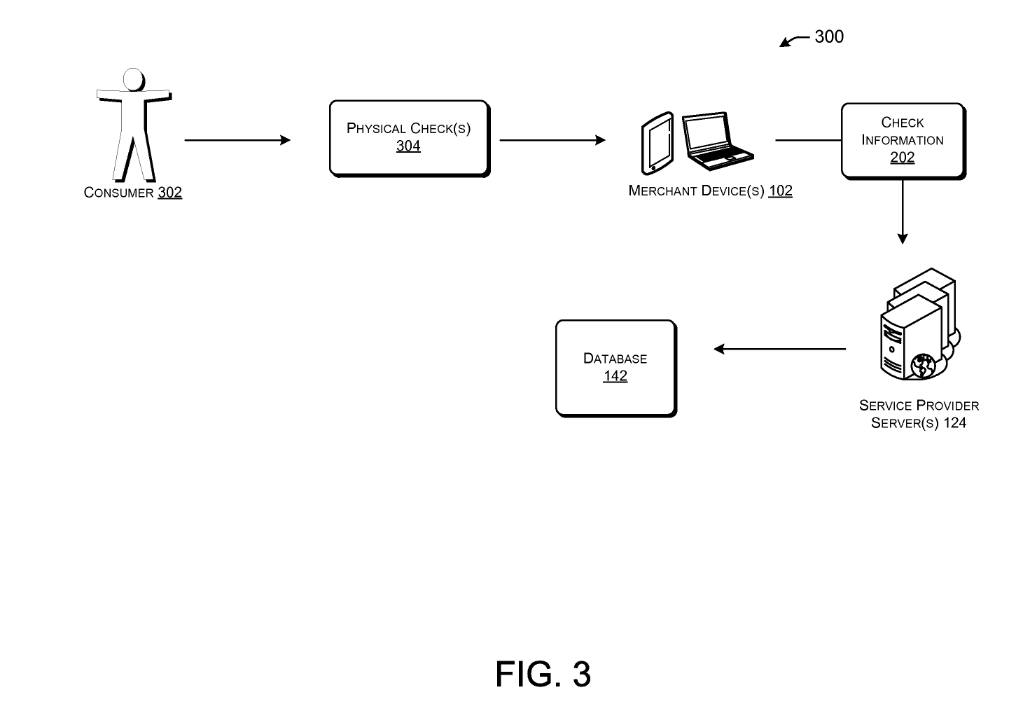

Turning now to FIG. 3, a block diagram of a data flow 300 for postponing check settlement is illustrated according to one or more example embodiments. The data flow 300 may include a consumer 202 that provides a physical check 304 to a merchant device(s) 102, which may be a point of sale device. The merchant device(s) 102 may be configured to convert the physical check 304 into electronic form, such as by performing OCR via the check conversion module 118 on one or more images of the physical check 304. Based at least in part on the OCR, the check application 110 and/or the check conversion module 118 may generate and/or determine check information 202 associated with the physical check 304. In some implementations, the check information 202 may be provided by a user of merchant device 102 (e.g., the user may manually or verbally input check information 202 to the merchant device 102).

According to one or more embodiments, the merchant device(s) 102 may be configured to transmit, such as via the check application 110, the check information 202 to the service provider server(s) 124. As such, the service provider server(s) 124 may be configured to determine, from the check information 202, a source account identifier 204. To this end, the service provider server(s) 124 may access the database to determine and/or identify any user accounts that include an account identifier that corresponds to the source account identifier 204. Upon a positive determination of a match between the source account identifier 204 and an account identifier, the service provider server(s) 124 may be configured to determine whether the user profile indicates any preference to delay and/or postpone settlement of checks that are to withdraw funds from the account associated with the account identifier. If there is such an indication and/or preference, the service provider server(s) 124 may be configured to determine, based at least in part on the indication, a post settlement date for the physical check 304. As such, the service provider server(s) 124 may store an association between the check information 202 of physical check 304, a destination account identifier, and post settlement date. Such an association may be stored in the database 142, such as in the settlement table 146.

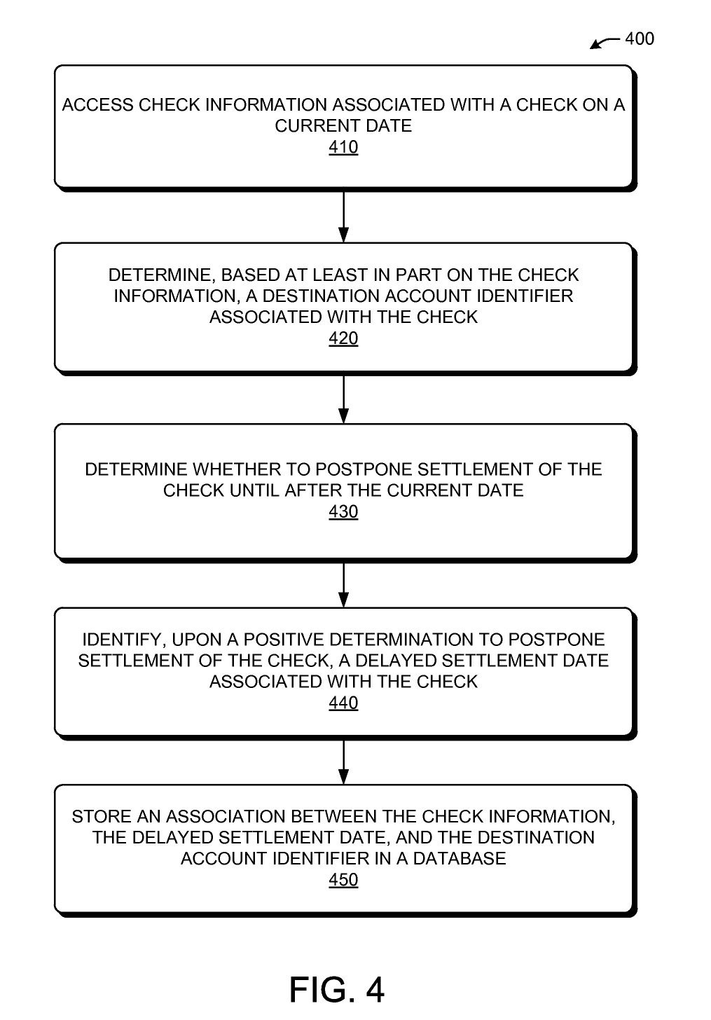

Turning now to FIG. 4, a flow diagram of a method 400 for digital check conversion is illustrated according to one or more example embodiments. The method 400 may include block 410, in which a computer, such as a merchant device 102, service provider server 124, and/or a combination thereof may receive and/or otherwise access check information 202 associated with a check 304 on a current date. In block 420, the computer may determine a destination account identifier for the check. In block 430, the computer may determine whether to postpone settlement of the check until after the current date. In block 440, the computer may identify, upon a positive determination to postpone settlement of the check, a delayed settlement date associated with the check. In block 450, the computer may store an association between the check information 202, the delayed settlement date, and the destination account identifier in a database 142 in communication with the computer.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

The claimed invention is:

1. A method, comprising:
receiving, by a computer comprising one or more processors, check information associated with a check on a current date;
determining, by the computer based at least in part on the check information, a destination account identifier for the check;
determining whether to postpone settlement of the check until after the current date;
identifying, by the computer upon a positive determination to postpone settlement of the check, a delayed settlement date associated with the check; and
storing an association between the check information, the delayed settlement date, and the destination account identifier in a database in communication with the computer.

2. The method of claim 1, wherein the positive determination to postpone settlement of the check comprises:
identifying, based at least in part on the check information, a source account identifier;
accessing, from the database, a user profile associated with the source account identifier; and
determining, based at least in part on the user profile, an indication to postpone settlement of checks that withdraw from the source account.

3. The method of claim 2, wherein the indication is to postpone settlement by a predetermined number of days.

4. The method of claim 2, wherein the indication is to postpone settlement until the delayed settlement date.

5. The method of claim 1, wherein determining whether to postpone settlement of the check comprises:
receiving, from the user, a request to postpone settlement of the check until the delayed settlement date.

6. The method of claim 1, wherein the check information comprises data associated with at least one of a source account, a payor, a payee, an amount, a check number, or a date.

7. The method of claim 1, further comprising:
accessing a settlement table stored in the database, wherein the settlement table is configured to store one or more associations between respective settlement dates and respective check settlement information;
identifying, based at least in part on the access of the settlement table, check settlement information associated with a second check; and
performing settlement of a second check according to the check settlement information associated with the second check.

8. A device, comprising:
at least one processor;
at least one memory storing computer-executable instructions, that when executed by the at least one processors, cause the at least one processor to:
receive check information associated with a check on a current date;
determine, based at least in party on the check information, a destination account identifier for the check;
determine whether to postpone settlement of the check until after the current date;
identify, upon a positive determination to postpone settlement of the check, a delayed settlement date associated with the check; and
store an association between the check information, the delayed settlement date, and the destination account identifier in a database in communication with the device.

9. The device of claim 8, wherein the positive determination to postpone settlement of the check comprise further instructions to:
identify, based at least in part on the check information, a source account identifier;
access, from the database, a user profile associated with the source account identifier; and
determine, based at least in part on the user profile, an indication to postpone settlement of checks that withdraw from a source account corresponding to the source account identifier.

10. The device of claim 9, wherein the indication is to postpone settlement by a predetermined number of days.

11. The device of claim 9, wherein the indication is to postpone settlement until the delayed settlement date.

12. The device of claim 8, wherein the instructions to determine whether to postpone settlement of the check comprise further instructions to:
receive, from the user, a request to postpone settlement of the check until the delayed settlement date.

13. The device of claim 8, wherein the check information comprises data associated with at least one of a source account, a payor, a payee, an amount, a check number, or a date.

14. The device of claim 8, wherein the instructions further cause the at least one processor to:
access a settlement table stored in the database, wherein the settlement table is configured to store one or more associations between respective settlement dates and respective check settlement information;
identify, based at least in part on the access of the settlement table, check settlement information associated with a second check; and
perform settlement of a second check according to the check settlement information associated with the second check.

15. A non-transitory computer-readable medium comprising computer-executable instructions, that when executed by at least on processor, causes the at least one process to:
receive check information associated with a check on a current date;
determine, based at least in party on the check information, a destination account identifier for the check;
determine whether to postpone settlement of the check until after the current date;
identify, upon a positive determination to postpone settlement of the check, a delayed settlement date associated with the check; and
store an association between the check information, the delayed settlement date, and the destination account identifier in a database in communication with the device.

16. The computer-readable medium of claim 15, wherein the positive determination to postpone settlement of the check comprise further instructions to:
identify, based at least in part on the check information, a source account identifier;
access, from the database, a user profile associated with the source account identifier; and
determine, based at least in part on the user profile, an indication to postpone settlement of checks that withdraw from a source account corresponding to the source account identifier.

17. The computer-readable medium of claim 16, wherein the indication is to postpone settlement by a predetermined number of days.

18. The computer-readable medium of claim 16, wherein the indication is to postpone settlement until the delayed settlement date.

19. The computer-readable medium of claim 15, wherein the instructions to determine whether to postpone settlement of the check comprise further instructions to:
receive, from the user, a request to postpone settlement of the check until the delayed settlement date.

20. The computer-readable medium of claim 15, wherein the instructions further cause the at least one processor to:
access a settlement table stored in the database, wherein the settlement table is configured to store one or more associations between respective settlement dates and respective check settlement information;
identify, based at least in part on the access of the settlement table, check settlement information associated with a second check; and
perform settlement of a second check according to the check settlement information associated with the second check.
